(19) United States
(12) Patent Application Publication
(10) Pub. No.: US 2005/0201726 A1
(43) Pub. Date: Sep. 15, 2005

(54) Remote playback of ingested media content

(75) Inventors: Michael A. Malcolm, Aspen, CO (US); Daniel A. Collens, Waterloo (CA); Stephen Watson, Toronto (CA)

Correspondence Address: SWERNOFSKY LAW GROUP PC, P.O. BOX 390013, MOUNTAIN VIEW, CA, 94039-0013, US

(73) Assignee: Kaleidescape, Mountain View, CA (US)

(21) Appl. No.: 10/801,091

(22) Filed: Mar. 15, 2004

(51) Int. Cl. H04N 5/76; G11B 15/04; G11B 19/04

(52) U.S. Cl. 386/94; 386/124; 360/60; 380/201

(57) ABSTRACT

A system including: (a) a media reader including a read element for physical media, the physical media including digital content representing at least one media stream, the digital content being maintained in a protected form; (b) a storage element coupled to the media reader, the storage element using a storage mechanism different from the physical media, the storage element non-evanescently storing the digital content in the protected form; and (c) a playback device coupled to the storage element, the playback device receiving the digital content and outputting analog, digital, or analog and digital audiovisual content for presentation. The digital content is stored in the storage element in the protected form, sent from the media reader to the storage element in the protected form, sent from the storage element to the playback device in the protected form, and output by the playback device in a second protected form.

### BACKGROUND OF THE INVENTION

1. Field of the Invention

This invention relates to remote playback of imported media content, such as for example playback of imported media content from a digital video disk (DVD) at a logically remote location using only limited communication bandwidth; as described herein, “remote” playback includes remoteness due to space, time, or logical distance.

2. Related Art

Portable digital media, for example DVDs, have become one of the preferred vehicles for storing and selling audio and visual content, for example movies and television programs. Such media permits high-resolution reproduction of the content.

One drawback of traditional digital media is that only a limited amount of the media usually can be placed in a player at once. For example, most DVD players accept only a limited number of DVDs at once.

Another emerging phenomenon is a trend toward integrating home computers, cable and Internet access, and entertainment centers (including televisions and high definition displays) together. This integration can make a large amount of memory and computing power available for use by playback devices and the like.

Given such an arrangement, it would be advantageous to be able to download media content to centralized storage, which could be (for one example) at a logically remote location from the physical media. This storage could then contain digital content from many different sources, for example the Internet, DVDs, digital audio tapes, and the like. Because of the digital nature of the content, a substantially perfect copy can be stored, allowing for high-quality playback on demand. Playback also could be at a location logically remote from the media and from storage.

The ability to make a substantially perfect copy of digital media has a significant drawback. In some circumstances, it would be possible to copy the information from the DVD or other digital media, to make unauthorized copies of the digital content. Accordingly, producers of digital content typically insist upon strict standards for the media and for devices that can access and play the media.

One such standard that is used for DVDs is the Content Scramble System (CSS). CSS is one example of “Digital Rights Management” (DRM). Other types of DRM exist for digital media. CSS sets forth procedures for devices that access digital content on media such as DVDs and that output the digital content, either in digital form or after conversion to an analog form.

One aspect of CSS is that a DVD reader only reads digital data from a DVD after the CSS compliant DVD reader authenticates that the data is going to be sent to a CSS compliant decryption module or descrambler. A CSS compliant DVD reader (herein sometimes called a “DVD drive,” and distinct from a “media reader” as described herein) reads data and key materials from the DVD and sends the data and key materials to a destination for playback only after such authentication. By known techniques, each CSS compliant descrambler is capable of extracting a decryption key from those key materials.

Accordingly, it would be advantageous to provide a technique for logically remote storage and playback of content stored on digital media, such as for example on a DVD, that complies with relevant standards for digital rights management.

### SUMMARY OF THE INVENTION

One aspect of the invention is a system that addresses the foregoing needs. This system preferably includes a media reader, a storage element, and a playback device.

The media reader includes a read element for physical media that includes digital content representing at least one media stream. The digital media is maintained in a protected form on the physical media. In other words, no descrambling takes place in the media reader. In a preferred embodiment, no DRM (digital rights management) restrictions or information are removed by the media reader, either. More specifically, in a preferred embodiment, when there is mutual authentication between the DVD drive and media reader, key materials needed to access the digital content are communicated, but with a first additional layer of encryption; when the key materials are maintained on the storage element, that first additional layer of encryption has been replaced with a second additional layer of encryption.

In one embodiment, the media reader includes a DVD drive and the physical media includes at least one DVD. In this embodiment, the DVD drive includes a first authenticator (herein sometimes called an “authenticator for DVD drive”) and the media reader includes a second authenticator (herein sometimes called an “authenticator for CSS decryption”). Accordingly, the overall system complies with CSS procedures using the first authenticator and the second authenticator before the DVD drive permits access to data on the DVD. As noted above, no actual CSS descrambling is performed by the media reader, and the media reader preferably maintains all DRM information intact. As noted herein, the second authenticator might be disposed within the storage element, the playback device, or elsewhere.

In one embodiment, the storage element is coupled to the media reader and uses a storage mechanism different from the physical media. For one example, not intended to be limiting in any way, the storage element might include a magnetic disk drive, or any other physical media in which digital information is stored in a substantially different form from a physical DVD.

In one embodiment, the storage element stores the digital content in the same protected format as on the original physical media (that is, without removing or altering any of the DRM information associated with the original physical media), for a substantially non-evanescent time (that is, for more than required for store-and-forward routing or other true storage techniques). Preferably, the digital content is sent from the media reader to the storage element in its original protected form, stored on the storage element in that original protected form, sent from the storage element to the playback device in that original protected form, and decoded and presented by the playback device. In preferred embodiments, presentation by the playback device might include output to a secondary presentation device in a second protected form, such as for example a form using digital encryption or using a Macrovision technique.

Storage of the digital content in the storage element permits access to the content without having to use the physical media. In a preferred embodiment, digital content from a large number of media can be stored, creating a virtual juke-box without the hardware needed to physically access a large number of media. Furthermore, because the digital content is kept in a protected form, unauthorized copying is discouraged.

In one embodiment, the storage element includes a mass storage device, such as for example a magnetic disk drive or an array of disk drives controlled by a file server or other storage element controller, or a RAID (“redundant array of inexpensive disks”) controlled by a RAID system controller or other storage element controller.

The playback device is coupled to the storage element. The playback device receives the digital content and outputs analog, digital, or analog and digital audiovisual content for presentation.

If one possible output from the playback device is an analog signal, the second protected form by which the analog signal is protected preferably includes a form of analog copy protection such as for example Macrovision technology. If one possible output from the playback device is a digital signal, the second protected form by which the digital signal is protected preferably includes a form of digital copy protection, such as for example HDCP or some other suitable digital copy protection protocol.

Because the digital content is always protected by at least one form of protection (at least until it reaches one or more of the playback devices), transmission of the content can be performed without substantial risk of unauthorized copying. Moreover, the system can communicate internally without allowing any outputs that are not protected according to the CSS specification. Therefore, the foregoing system permits the various elements to be substantially logically, physically, or even temporally remote. The digital content can be transported a substantial distance after being read by the media reader and before being output by the playback device. Similarly, the digital content can be stored for a non-evanescent duration.

In another embodiment, a plurality of playback devices might be present, with at least two of those playback devices being substantially physically remote from each other, or with at least one of those playback devices being substantially physically remote from the storage element. Thus, one storage device can serve plural playback devices, such as for example plural televisions in a single home. In one embodiment, digital elements of the playback devices receive protected outputs from the system, where those protected outputs might have different formats and might involve different digital methods of de-protection for presentation to users.

In the context of the invention, there is no particular requirement that all such devices be identical, so for example, not intended to be limiting in any way, such plural devices might be of different kinds and might accept substantially different signals.

In a preferred embodiment, the system includes at least one system internal link, coupling at least one pair of elements. The system internal link preferably includes a communication link, capable of communicating compressed digital data representing media streams but not intended to effectively and timely communicate uncompressed digital data representing media streams.

In a preferred embodiment, DRM information (including any key information) included in the original DVD media is communicated using the system internal link. Neither the original media stream nor its associated DRM information (which includes at least a set of key materials, which include at least a key needed to decrypt the digital content) is substantially accessible to an external entity without an authorized cryptographically secure key.

In various embodiments, the media reader and the storage element can be coupled by a least one such system internal link, the storage element and the playback device can be coupled by a least one such system internal link, and/or the media reader and the playback device can be coupled by a least one such system internal link.

Other embodiments of the invention include the elements of the foregoing systems, methods utilized by the systems, memories such as storage media that include instructions for performing those methods, and the like.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE FIGURES

FIG. 1 shows an overview of layers of data content stored on physical media, in this case a DVD.

FIG. 2 shows a system for logically remote storage and playback of digital content that preserves digital right management protection.

FIG. 3 shows a flowchart for logically remote storage and playback of digital content that preserves digital right management protection.

### DETAILED DESCRIPTION OF THE PREFERRED EMBODIMENT

System Elements

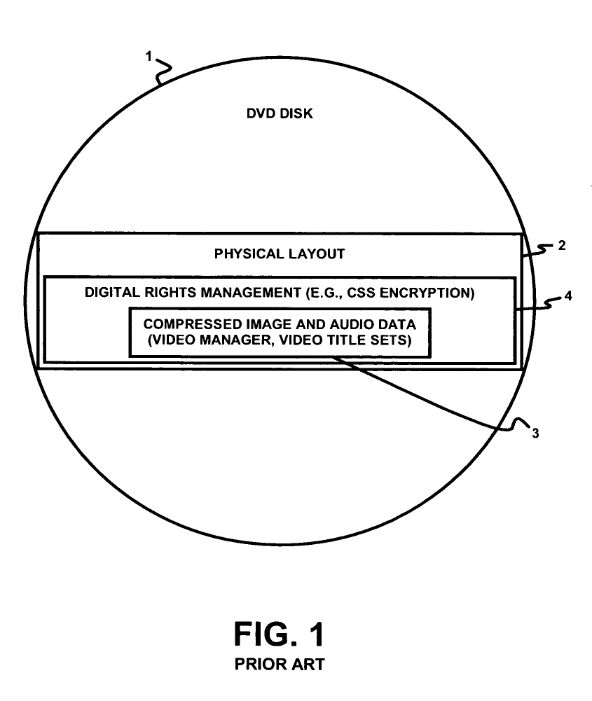

FIG. 1 shows an overview of layers of data content stored on physical media, in this case a digital video disk (DVD). The invention is not limited to use with DVDs. The invention is equally applicable to use with any physical media that stores data protected by some form of digital rights management.

In FIG. 1, DVD 1 stores digital content representing a media stream in accordance with physical layout 2. The physical layout specifies where data is stored physically on the disk, for example in a collection of circular tracks on the DVD.

In order to help increase an amount of data that can be stored on DVD 1, data preferably is stored in a compressed form. Thus, compressed image and audio (i.e., audio-visual) data 3 is stored on DVD 1 in accordance with physical layout 2. This data preferably utilizes a standard DVD, VCD, or other storage format. For example, FIG. 1 shows that the data includes a video manager and video title sets according to a DVD format. Other formats can be used.

The advantage of compressed data, namely that a large amount of audiovisual data can be stored on a single DVD, also has a drawback: The same digital data can be easily copied. Accordingly, data 3 preferably is protected by some form of digital rights management 4.

In a preferred embodiment, digital rights management 4 conforms to that Content Scramble System (CSS) standard. This standard provides for encryption of the compressed data by media keys that are stored on the media. These stored media keys are in turn encrypted using various device keys known to authorized playback devices. Preferably, the device keys are authorized and suitably cryptographically secure keys.

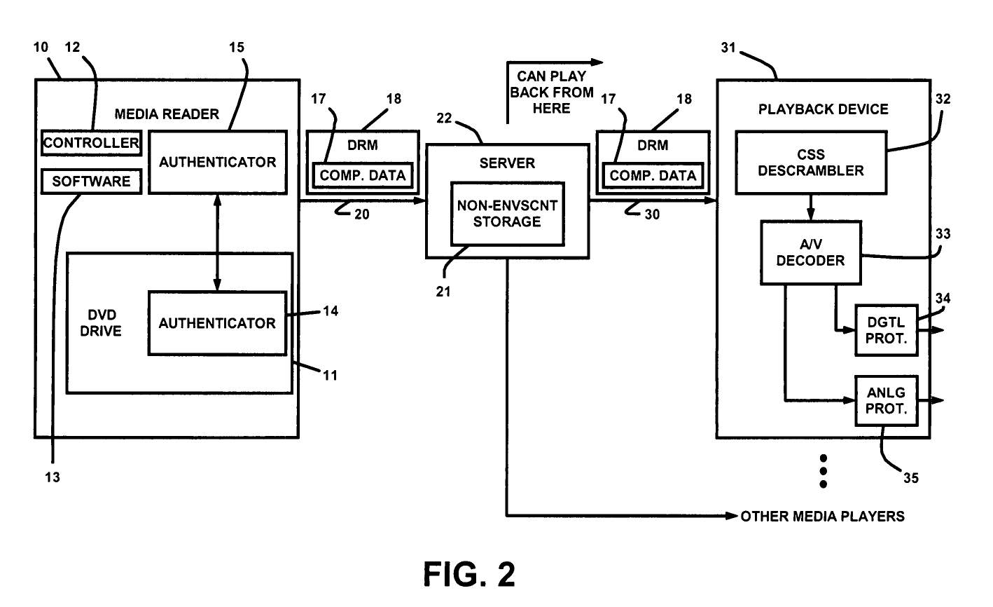

FIG. 2 shows a system for logically remote storage and playback of digital content that preserves digital right management protection.

Briefly, one embodiment of such a system includes a media reader, a storage element, and a playback device. The media reader includes a read element for physical media such as a DVD. The storage element is coupled to the media reader and uses a storage mechanism different from the physical media to non-evanescently store the digital content in the protected form. The playback device is coupled to the storage element, preferably by a secured communication link (as described herein), such as for example an encrypted signal over a LAN in a home network, or another type of communication like (whether secured or not), such as for example a signal using an Ethernet LAN in a home network. The playback device receives the digital content and outputs analog, digital, or analog and digital audiovisual content for presentation. In this embodiment, the digital content is stored in the storage element in the protected form, sent from the media reader to the storage element in the protected form, sent from the storage element to the playback device in the protected form, and output by the playback device in a second protected form.

Thus, FIG. 2 shows media reader 10 that includes a read element shown as DVD drive 11. The media reader also preferably includes controller 12 and software 13 that control the operation of the elements of the media reader.

Other types of read elements corresponding to other types of physical media besides DVDs are within the scope of the invention. However, for the sake of simplicity, the invention will be described herein with respect to a DVD drive. No undue experimentation or further invention would be required to apply the system of FIG. 2 to another type of physical media and corresponding read element.

Media reader 10 preferably complies with Content Scramble System (CSS) procedures. To this end, DVD drive 11 is shown with first authenticator 14, and media reader 10 is shown with second authenticator 15. In a preferred embodiment, first authenticator 14 and second authenticator 15 authenticate each other before DVD drive 11 permits access to data on a DVD.

Once authentication is performed, DVD drive 11 (or some other read element) reads data from a DVD (or other media). The data is then output from media reader 10.

Preferably, the data is output from media reader 10 in the same form as it was stored on the DVD, including all digital rights management features. Thus, FIG. 2 shows that compressed data 17 output from media reader 10 is wrapped by digital rights management 18. In a preferred embodiment, the physical media includes a DVD, and the compressed data thereon was encrypted using a CSS encryption technique, already available on purchased DVDs. The media reader 10 reads both compressed digital data (representing a media stream) and also key material, from the DVD, retaining both in their original form (that is, there is no need to decrypt either the digital data or unpack the key material, as yet). The key material includes at least one key for decrypting the digital data, which the playback device can determine in response to the key material. In various embodiments, the actual operations to be carried out may be substantially different for distinct playback devices.

Media reader 10 sends the output data over link 20 to non-evanescent storage 21, for example mass storage in file server 22.

Storage 21 could be a disk drive or an array of disk drives. Alternatively, different types of storage, either managed by a server or not associated with a server, could be used. In any case, the storage element preferably has capacity to store digital content from plural physical media. The data preferably can be stored at storage 21 for a substantial time duration before being sent on to a playback device.

According to a preferred embodiment of the invention, the data including digital rights management features can be sent to any of plural playback devices from non-evanescent storage 21. For example, if server 22 is in a household, a switch or router could be used to send the data to any one of plural playback devices in the house. Other arrangements are within the scope of the invention, for example use of the World Wide Web.

Preferably, the data is output from the storage element in the same form as it was stored on the DVD, including all digital rights management features. Thus, FIG. 2 shows that compressed data 17 output from server 22 is wrapped by digital rights management 18.

The storage element sends the output data over link 30 to a playback device such as playback device 31.

Playback device 31 also preferably complies with CSS descrambling procedures at the playback device. Thus, playback device 31 in FIG. 2 includes CSS descrambler 32.

In the preferred embodiment, the CSS descrambler includes built-in device keys. These keys are used to decrypt media keys, in a direct or indirect manner, in the digital rights management portion of the data. The media keys are in turn used to descramble the audiovisual data, resulting in unscrambled compressed audiovisual data. In this arrangement, the media keys themselves are not substantially accessible to an external entity without an authorized device key.

In one preferred embodiment, the entire set of key material, considered as a single package, is encrypted at the media reader 10 using an AES encryption technique and a AES-256 key (that is, a symmetric 256-bit key). The encrypted key material, as well as the encrypted digital data, is maintained on the storage device without that storage device being able to access the AES-256 key. Authentication allows the encrypted key material, as well as the encrypted digital data, to be decrypted at the playback device when the playback device is able to access the AES-256 key. Unscrambled compressed audiovisual data is particularly susceptible to illicit copying. Therefore, the data should be protected, for example by restricting the unscrambled compressed data to internal busses within the playback device that are not user-accessible.

In a preferred embodiment, links internal to the overall system are used to communicate compressed data representing a media stream (i.e., digital content). These links are often unable to effectively and timely communicate uncompressed data representing the media stream. For one example, not intended to be limiting in any way, a system internal link might include a LAN using 100BaseT Ethernet technology in a home network. Links 20 and 30 in FIG. 2 are examples of such “system internal links” that might have these limitations.

In a more general sense, the system in FIG. 2 preferably includes at least one system internal link that is able to communicate compressed digital data representing media streams but substantially unable to effectively and timely communicate uncompressed digital data representing media streams. In the system, any key materials in data communicated using the system internal link preferably is not substantially accessible to an external entity without an authorized cryptographically secure key. Preferably, the media reader and the storage element are coupled by at least one of the system internal links, the storage element and the playback device are coupled by at least one of the system internal links, and/or the media reader and the playback device are coupled by at least one of the system internal links.

Playback device 31 also includes an audio-visual decoder 33, which decompresses the data into analog, digital, or analog and digital audiovisual data (i.e., a media stream).

The uncompressed audiovisual data is also susceptible to illicit copying. Therefore, the data still should be protected, for example by restricting the uncompressed audiovisual data to internal busses within the playback device.

Digital protection chip 34 and analog protection chip 35 are provided for adding a second form of copy protection to the audiovisual data. This second form of copy protection is different from the copy protection provided by digital rights management 18. In one embodiment, one or both of the digital protection chip 34 and analog protection chip 35 might be included within the same circuitry or the same chip package, and might be coupled to a digital/analog converter, an analog/digital converter, or an MPEG decoder.

In more detail, digital protection chip 34 preferably adds HDCP copy protection. Similarly, analog protection chip 35 preferably adds analog copy protection such as “Macrovision” copy protection.

In the preferred embodiment, the audiovisual data is output from the playback device only after the second form of copy protection has been added, for example through HDMI/DVI output jacks. A standard output device such as a television, high definition television, projector or the like can then be connected to one or more of the jacks for presentation of the audiovisual media. Such an output device preferably can receive a signal protected with the second form of copy protection. Examples of the output device include, but are not limited to, a display that has a DVI/HDMI input or a television that is able to handle an analog signal to which analog copy protection using Macrovision technology has been added.

In addition to this use of a second form of copy protection, the quality of audio and video output is preferably restricted below a designated level, as collectively described in the CSS license agreement and the CSS procedural specifcation. For example, digital audio outputs might preferably carry audio data that is descrambled, and either in Dolby Digital or DTS formats, or else in Linear PCM format in which the transmitted information is sampled at no more than 48 kHz and no more than 16 bits. The analog audio output signals are preferably obtained by digital-to-analog conversion of a 2-channel Linear PCM signal, similarly sampled at no more than 48 kHz and no more than 16 bits. In a preferred embodiment, it should not be possible to output descrambled, decompressed, analog video data on a RGB output other than as permitted as part of a SCART connector. In a preferred embodiment, it should not be possible to output a video signal with resolution higher than standard definition unless the video content is recorded itself on the physical media in that higher resolution.

One advantage of the system described with regard to FIG. 2 is that at least two of the media reader, the storage element, and the playback device can be logically remote, physically remote, or both.

Logically remote refers to devices that are remote in terms of their logical structures. For example, devices that use separate logical processing spaces, separate operating systems, separate memory spaces, separate storage elements, and/or separate processors can all be considered to be logically remote from each other. Devices that are functionally separate or logically distant, such as for example devices that are coupled by an intermediate device, a router or switch, or can be freely coupled or decoupled, are also considered logically remote from each other. In the context of the invention, there is no particular hardware or software requirement that is required to make devices logically remote or not.

Physically remote refers to devices that are physically separate from each other by any significant (in terms of data communication) distance. For example, current state-of-the-art devices that are more than about 50 cm apart presently require separate processors in order to operate efficiently. Thus, 50 cm is a significant distance for such devices. (With changes in technology, other distances might be appropriate at which to distinguish physical remoteness.) Likewise, devices in separate parts of a room, in separate rooms, in separate buildings, and devices that are separated by larger distance are all “physically remote” to varying degrees.

The capability for the elements of the system to be remote from each other provides for a great many possible arrangements of the devices, both in commercial and home settings. This also provides for a great many possible arrangements in which the digital data, or the DRM information, or the key materials from the DRM information, or some selection thereof, are protected by a cryptographically secure key. In these arrangements, the digital content can be transported any substantial distance after being read by the media reader and before being output by the playback device. Alternatively, the devices could be placed in close proximity to each other.

Furthermore, in a preferred embodiment, the DRM wrapped data can be selectively sent to one or more of plural playback devices that are remote from each other. For example, the DRM wrapped data can be sent to plural playback devices in a household, or across the World Wide Web or some other network to subscribers of a media distribution service. This opens the door to a great many commercial opportunities for more efficient distribution of audiovisual media content.

Method of Operation

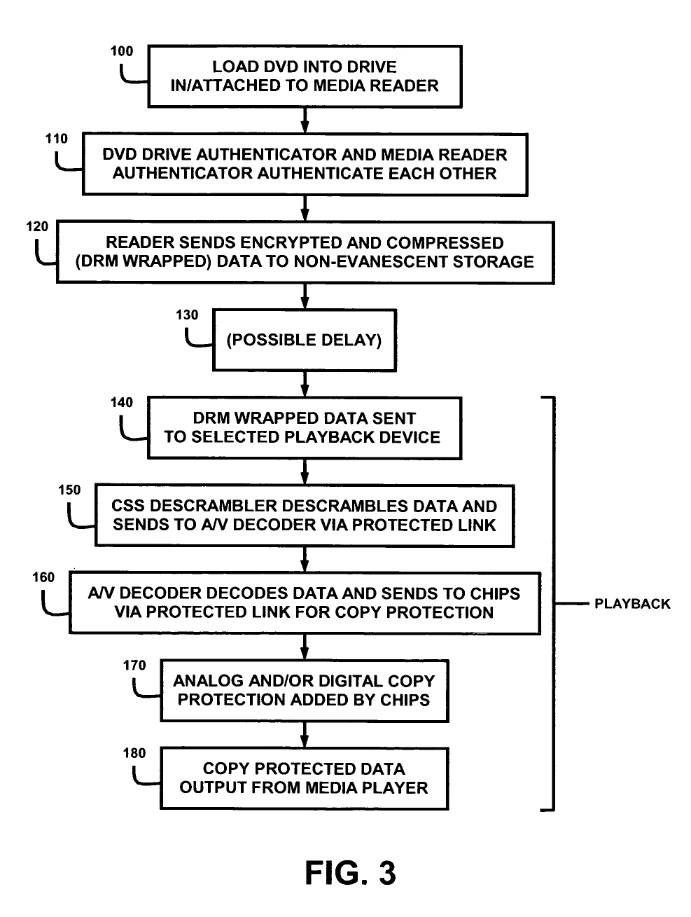

FIG. 3 shows a flowchart for logically remote storage and playback of digital content that preserves digital right management protection.

Briefly, one embodiment of such a method includes the following steps: reading physical media including digital content representing at least one media stream, the digital content being maintained in a protected form; non-evanescently storing the digital content in the protected form using a storage mechanism different from the physical media; and playing back the digital content after conversion into analog, digital, or analog and digital audiovisual content in a second protected from for presentation.

Steps for one possible embodiment of the invention are discussed below with reference to FIG. 3. Preferably, the steps are executed in the order shown. However, the invention also encompasses embodiments in which the steps are executed in different orders, where possible, and in different arrangements, for example in parallel.

In a preferred embodiment, physical media containing data representing a media stream is loaded into a read element of a media reader. For example, and without limitation, the physical media could be a DVD, and the read element could be a DVD drive.

Preferably, the read element (e.g., DVD drive) includes a first authenticator, and the media reader includes a second authenticator. In step 110, the first authenticator and the second authenticator authenticate each other before the read element permits access to data on the physical media.

The media reader sends the data, which is still protected by digital rights management elements preferably identical to those on the physical media, to non-evanescent storage in step 120. In a preferred embodiment, the key materials present on the DVD are wrapped in another layer of encryption before being sent. In some embodiments, this concept of “wrapped” includes the possibility that those key materials are encrypted using a second layer of encryption by the DVD drive, and this second layer removed by the media reader, before the key materials are sent. For example, for a DVD that conforms to CSS requirements, the data is still compressed, encrypted with a media key, which in turn is present on the DVD (directly or indirectly) encrypted by a secure device key.

An optional delay, which preferably may be of substantially any desired duration, occurs at step 130.

At step 140, the digital rights management wrapped data is sent to one or more playback devices, which might be selected from plural available playback devices.

Steps 120 to 140 can occur all in one logical or physical location, or can occur between plural logically or physically remote locations. In other words, the media reader, storage, and playback device can be logically or physically proximate or remote from each other. Furthermore, the protected data preferably can be sent to a plurality of playback devices for presentation, and those devices preferably can be pairwise substantially physically remote from each other.

In preferred embodiments, there are hardware implementations of the playback device and the media reader preferably designed in a manner in which they effectively frustrate (1) attempts to defeat or circumvent the copy protection functions related to descrambling or authentication, (2) attempts to discover decrypted confidential keys, and (3) attempts to discover confidential information about the CSS Security Algorithms. As described herein, the CSS Security Algorithms include particular techniques for encrypting and decrypting digital data, but the invention is also applicable using different techniques.

In a preferred CSS compliant device, hardware implementations of the playback device and the media reader are preferably designed so that it is reasonably certain that such attempts are impossible using “User Tools,” and difficult using “Professional Tools.” “User Tools” include tools or equipment that are widely available at a reasonable price, such as screwdrivers, jumpers, clips and soldering irons, and specialized electronic or software tools that are widely available at a reasonable price, such as eeprom readers and writers. “Professional Tools” include professional tools or equipment, such as chip disassembly systems or in-circuit emulators and specialized devices or technologies, whether hardware or software, that are designed and made available for the purpose of bypassing or circumventing CSS copy protection technologies.

At step 150, the data is descrambled, preferably in accordance with CSS descrambling procedures. In a preferred embodiment, a device key known to the playback device is used, directly or indirectly, to extract a media key from the data. This media key is then used to decrypt the audiovisual data, resulting in compressed descrambled audiovisual data for the media stream.

The compressed descrambled data is decoded, decompressed, and then sent to one or more circuits or chip packages for digital-analog conversion and the addition of new copy protection in step 160. These circuits or chip packages might include multiple circuits consolidated within a single package, or vice versa, and might include elements for conversion between analog and digital, and might include elements for decoding (such as for example MPEG decoding). At this point, the data represents uncompressed and unencrypted audiovisual data (i.e., a media stream).

New copy protection is added to the media stream in step 170. This copy protection preferably is of a different form that the copy protection provided by the digital rights management on the physical media. For example, and without limitation, HDCP protection can be added to digital data, and Macrovision protection can be added to analog data.

Preferably, CSS compliant procedures are observed throughout steps 110 to 180. Thus the hardware implementations of the media reader and the playback device should be designed so that: decrypted confidential keys are not available outside integrated circuits; so that unencrypted compressed audiovisual data is not carried on a “user accessible bus” (as defined herein); so as to prevent users from having ready access to exposed internal components such as switches, wires, connectors orjumpers by which copy protection technologies can be circumvented; and, when both commercially and technically reasonable, so that unencrypted decompressed data video data is not carried on a user accessible bus. As used herein, a “user accessible bus” includes any data bus which is designed for end user upgrades or access such as PCI, PCMCIA, or Cardbus, but not memory buses, CPU buses, and similar portions of a device's internal architecture.”

Thus, compressed and unencrypted data preferably is never substantially accessible to a user without use of professional equipment, and even then only with difficulty, until it is output from the playback device, at which point it is protected with some digital or analog form of copy protection. Any transmission of data between remote elements of the system preferably is restricted to system internal links that are able to communicate compressed digital data representing media streams but are substantially unable effectively and timely to communicate uncompressed digital data representing media streams. Furthermore, any communication of unencrypted key materials (e.g., device keys or decrypted media keys) preferably is not substantially accessible without use of professional equipment.

In a preferred embodiment, a set of system software is preferably encrypted and is preferably authenticated before components of the system are able to boot. This has the effect that without a storage element, the media reader cannot obtain its software from an authenticated (or indeed, any) storage element. This itself has the effect that without a storage element, the media reader cannot operate any such software to output any audiovisual data.

In a preferred embodiment, the media reader encrypts the digital content for storage on the storage element, with the effect that the playback device is only able to read that digital content if it is authentic. Similarly, the DRM information from the DVD (including key materials) are wrapped in an encryption later, with the effect that snooping on the system internal link between the media reader and the storage element, or on the system internal link between the storage element and the playback device, would not serve to recover decrypted digital content.

In a preferred embodiment, a high degree of concern is taken for security and integrity. The hardware and the software of the system are preferably substantially unlike those of a personal computer (a “PC”). The operating system is preferably a proprietary embedded operating system and not one based on a general-purpose operating system like Linux or Windows. There is preferably no publicly available documentation that describes how the system software is implemented, and it is preferably not feasible for the user or other persons to add any software to the system. Such systems are well known in the art, and incorporation of such systems into the invention would require no invention or undue experimentation. Preferably, no schematics that would indicate how to illicitly access the hardware components of the system are publicly available, and the system has no internal user-accessible buses of any kind. The hard disks in the storage element are preferably embedded in disk cartridges that use a proprietary adapter that cannot be plugged into a PC, and the structure and operation of the file system on these disks is preferably not publicly available. In particular, a preferred embodiment would not allow a PC running Windows, Mac OS, Linux, or a variant of UNIX to make sense of the data stored on the storage element, except with considerable difficulty.

In the preferred embodiment, a user is preferably only able to interact with the components of the system either through the on-screen display, the associated touchpad and IR remote control protocols, and through the Web user interface. The software for each component of the system, including the media reader and the playback devices, is preferably stored on the Server in an encrypted form. Upon booting the media reader or the playback devices, the applicable software is preferably transferred from the storage element, in an encrypted form, to the media reader or the one or more playback devices, where it is preferably loaded into memory, decrypted, and checked for integrity before being allowed to start.

In the preferred embodiment of the invention, the only component of the apparatus that ever manipulates unscrambled audiovisual data or plain text keys is the playback device. The playback device preferably has custom-designed printed circuit boards. These circuit board should have ten layers or more and, wherever technically feasible, sensitive signals should be run on interior layers where they are more difficult to probe by a skilled technician. In the preferred embodiment, extensive use should be made of surface-mount area-array packaging technology throughout the playback device and signals carrying sensitive data should be run along the interior contacts of area-array integrated circuits wherever feasible.

In some embodiments, even further copy and/or access protection techniques are used for the physical media, the storage element/mechanism, or both. These additional protection techniques need not be the same for the physical media and the storage element/mechanism.

Alternative Embodiments

The invention can be embodied in a method for logically remote storage and playback of digital content that preserves digital rights management protection, as well as in software and/or hardware such as a reader, non-DVD storage, computer, playback device, and the like that implements the method, and in various other embodiments.

In the preceding description, a preferred embodiment of the invention is described with regard to preferred process steps and data structures. However, those skilled in the art would recognize, after perusal of this application, that embodiments of the invention may be implemented using one or more general purpose processors or special purpose processors adapted to particular process steps and data structures operating under program control, that such process steps and data structures can be embodied as information stored in or transmitted to and from memories (e.g., fixed memories such as DRAMs, SRAMs, hard disks, caches, etc., and removable memories such as floppy disks, CD-ROMs, data tapes, etc.) including instructions executable by such processors (e.g., object code that is directly executable, source code that is executable after compilation, code that is executable through interpretation, etc.), and that implementation of the preferred process steps and data structures described herein using such equipment would not require undue experimentation or further invention.

Furthermore, the invention is in no way limited to the specifics of any particular preferred embodiment disclosed herein. Many variations are possible which remain within the content, scope and spirit of the invention, and these variations would become clear to those skilled in the art after perusal of this application. For example, although the focus of the preceding description is audiovisual content, the invention is equally applicable to solely audio content, visual content, multimedia content, and any other types of content protected by authentication procedures, digital rights management techniques, or both. Other variations and alternative applications exist.

CSS Procedural Specification

A preferred embodiment of the invention complies with Content Scramble System (CSS) Procedural Specifications, particularly section 5 (“Licensor Operating Procedures and Security Standards”) and section 6 (“Additional CSS Licensee Obligations”) of the CSS Procedural Specifications. A copy of the specifications is included in a technical appendix to this application. A copy of the specifications can also be found at http://cyber.law.harvard.edu/seminar/internet-client/readings/week2/02-08CSS.pdf Other embodiments of the invention can comply with different industry standards or to a set of custom security standards.

In the preferred embodiment, using the definitions given in the CSS Procedural Specifications, the invention includes a media reader, which is a Hardware Authenticator Module for CSS Decryption Module, coupled to a DVD Drive, containing a Authenticator Module for DVD Drive, and a playback device, which is a Hardware Descrambler. Again, using the definitions given in the CSS Procedural Specifications: the playback device incorporates and implements the functionalities of Disc Key Recovery Logic, Title Key Recovery Logic, and the Content Scrambling Algorithm and incorporates the Master Key pair; and the media reader incorporates and implements the functionality of the CSS Authentication Algorithm and incorporates the Authentication Key.

1. Apparatus, including
a storage element including an input disposed for receiving digital content from a physical medium, the storage element being capable of non-evanescently storing that digital content using a storage technique substantially different from the physical medium;
a playback device coupled to the storage element, the playback device having an input disposed for receiving the digital content and having an output disposed for coupling a media stream represented by that digital content for presentation; and
including a media reader, the media reader having a read element capable of being coupled to the physical medium.

2. Apparatus as in claim 1, wherein the output for presentation includes a signal following standards for protected signals specified by the CSS license.

3. Apparatus as in claim 1, whereby the playback device includes a CSS descrambler.

4. Apparatus as in claim 1, whereby the playback device incorporates and implements the functionalities of Disc Key Recovery Logic, Title Key Recovery Logic, and the Content Scrambling Algorithm, and incorporates the Master Key pair.

5. Apparatus as in claim 1, whereby the playback device does not incorporate or implement the functionality of the CSS Authentication Algorithm, or incorporate the Authentication Key.

6. Apparatus as in claim 1, whereby the media reader does not incorporates or implement the functionalities of any of Disc Key Recovery Logic, Title Key Recovery Logic, or the Content Scrambling Algorithm, or incorporate the Master Key pair.

7. Apparatus as in claim 1, whereby the media reader incorporates and implements the functionality of the CSS Authentication Algorithm, and incorporates the Authentication Key.

8. Apparatus as in claim 1, whereby the media reader is or contains an Authenticator for CSS Decryption Module and the playback device is or contains a Descrambler, such terms as defined in the CSS Procedural Specifications.

9. Apparatus as in claim 1, whereby, when each media reader boots, it obtains its operating software from the storage element.

10. Apparatus as in claim 1, whereby any operating software for a component of the apparatus, which is stored in the storage element, is encrypted when stored and transmitted between components, and decrypted and authenticated in the component for which it is such operating software, before said component becomes operative.

11. Apparatus as in claim 1, whereby, when each playback device boots, it obtains its operating software from the storage element.

12. Apparatus as in claim 1, whereby the operating software for the media reader, the storage element, and the playback device is not based on a general-purpose operating system such as Microsoft Windows, or Linux, or a version of Unix.

13. Apparatus as in claim 1, whereby the structure and operation of the file system in the storage element is a trade secret.

14. Apparatus as in claim 1, wherein the main printed circuit board of the playback device has at least five layers, and signals containing unscrambled compressed audiovisual data or key material run wherever feasible on traces in interior layers of the board.

15. Apparatus as in claim 1, wherein those integrated circuits in the playback devices signals containing unscrambled compressed audiovisual data or key material run are area-array and such signals run wherever feasible on interior contacts of such integrated circuits, and wherein those integrated circuits are surface-mounted.

16. Apparatus as in claim 1, whereby the user can only interact with the apparatus through either an on-screen display and associated touchpad and IR remote control protocols, or through a Web user interface.

17. Apparatus as in claim 1, whereby, the audio data output from the playback device is either in a compressed format or else in a Linear PCM format in which the transmission information is sampled at no more than 48 kHz and no more than 16 bits.

18. Apparatus as in claim 1, whereby, the analog video data output from the playback device does not have higher resolution than standard definition, unless the content recorded on the physical medium has itself that higher resolution.

19. Apparatus as in claim 1, wherein the playback device includes a plurality of those outputs disposed for presentation, at least two of those outputs pairwise having more than one controlling CPU and at least one of the properties in the set: being logically remote, being physically remote.

20. Apparatus as in claim 1, wherein the playback device includes at least one of those outputs disposed for presentation having a distinct controlling CPU from the storage element and having at least one of the properties in the set: being logically remote from the storage element, being physically remote from the storage element.

21. Apparatus as in claim 1, the digital content being maintained in a protected form
between the physical medium and the media reader,
between the media reader and the storage element,
when maintained on the storage element, and
between the storage element and the playback device.

22. Apparatus as in claim 21, wherein
at least two elements in the set: the storage element, the playback device, the media reader;
have, pairwise, at least two of the properties in the set: being logically remote, being physically remote, having more than one controlling CPU.

23. Apparatus as in claim 21, wherein
at least two elements in the set: the storage element, the playback device, the media reader;
are pairwise physically remote, and have separate controlling CPUs.

24. Apparatus as in claim 1, wherein the media reader includes at least one DVD reader.

25. Apparatus as in claim 1, wherein the media reader includes a DVD drive and the physical media includes at least one DVD.

26. Apparatus as in claim 1, wherein the storage element includes an array of magnetic disk drives wherein data is stored redundantly in such a way that all data may be recovered after the failure of any one disk drive therein.

27. Apparatus as in claim 1, wherein the digital content is maintained in a protected form for at least two cases in the set:
between the physical medium and the media reader;
between the media reader and the storage element;
when maintained on the storage element;
between the storage element and the playback device.

28. Apparatus as in claim 1, wherein the digital content is maintained in a protected form for at least three cases in the set:
between the physical medium and the media reader;
between the media reader and the storage element;
when maintained on the storage element;
between the storage element and the playback device.

29. Apparatus as in claim 21, wherein the protected form includes at least two of:
an encrypted form of the digital content;
an encrypted form of the digital content complying with the CSS license;
a form of the digital content including digital rights information;
a form of the digital content including digital rights information for which it is substantially difficult to remove that digital rights information.

30. Apparatus as in claim 21, wherein the protected form has at least one of the properties in the set:
resistant to attempts to defeat copy protection afforded by the protected form,
impossible to defeat using user tools,
difficult to defeat using professional tools.

31. Apparatus as in claim 21, wherein the protected form has at least two of the properties in the set:
resistant to attempts to defeat copy protection afforded by the protected form,
impossible to defeat using user tools,
difficult to defeat using professional tools.

32. Apparatus as in claim 21, wherein the protected form is substantially resistant to attempts to defeat copy protection afforded by the protected form, is substantially impossible to defeat using user tools, and is substantially difficult to defeat using professional tools.

33. Apparatus as in claim 1, wherein the media reader includes a first authenticator and the system exclusive of the media reader includes a second authenticator.

34. Apparatus as in claim 33, wherein the system complies with CSS procedures.

35. Apparatus as in claim 33, wherein the system is capable of having the first authenticator and the second authenticator authenticate each other before the media reader permits access to data.

36. Apparatus as in claim 33, wherein the system is capable of
using CSS descrambling procedures at the playback device.

37. Apparatus as in claim 1, wherein the storage element has capacity to concurrently store digital content from plural physical media.

38. Apparatus as in any of claims 1 or 20 or 21 or 32 or 33, wherein operation of the system includes at least a substantial time duration between a first time of storage of the digital content at the storage element, and a second time of output of any media stream derived in response thereto.

39. Apparatus as in any of claims 1 or 20 or 21 or 32 or 33, wherein the digital content is transported any substantial distance after being read by the media reader and before being output by the playback device.

40. Apparatus as in any of claims 1 or 20 or 21 or 32 or 33, including at least one system internal link, the at least one system internal link including a link able to communicate compressed digital data representing media streams;
wherein at least one of the following communicated using the system internal link is not substantially accessible to an external entity without an authorized cryptographically secure key: digital information representing at least one media stream, digital rights information, digital rights key information.

41. Apparatus as in claim 40, including steps of coupling by a least one system internal link, at least two of the set: the media reader, the storage element, the playback device.

42. A media reader, including
a read element for physical media, the physical media including digital content representing at least one media stream, the digital content being maintained in a protected form, and the read element including a first authenticator;
a second authenticator;
an interface to a storage element; and
a controller capable of (1) causing the first authenticator and the second authenticator to authenticate each other before the read element accesses the physical media, and (2) causing the read element to read data from the physical media and output the data to the interface with DRM information intact.

43. A media reader as in claim 42, wherein the read element includes a DVD drive.

44. A media reader as in claim 42, wherein the media reader can output the data to the storage element whether or not the storage element is logically remote from the media reader.

45. A method of playing media, including steps of
reading physical media including digital content representing at least one media stream, the digital content being maintained in a protected form;
non-evanescently storing the digital content in the protected form using a storage mechanism different from the physical media; and
playing back the digital content after conversion into analog, digital, or analog and digital audiovisual content in a second protected from for presentation.

46. A method as in claim 45, wherein additional protection is used on the physical media, by the storage mechanism, or both.

47. A method as in claim 46, wherein the additional protection used on the physical media is different from the additional protection used by the storage mechanism.

48. A method as in claim 45, wherein the protected form complies with CSS procedures.

49. A method as in claim 48, whereby the step of playing back incorporates and implements the functionalities of Disc Key Recovery Logic, Title Key Recovery Logic, and the Content Scrambling Algorithm, and involves the Master Key pair.

50. A method as in claim 48, whereby the step of playing back does not incorporate or implement the functionality of the CSS Authentication Algorithm, or incorporate the Authentication Key.

51. A method as in claim 48, whereby the step of reading does not incorporate or implement the functionalities of any of Disc Key Recovery Logic, Title Key Recovery Logic, or the Content Scrambling Algorithm, or incorporate the Master Key pair.

52. A method as in claim 48, whereby the step of reading incorporates and implements the functionality of the CSS Authentication Algorithm, and involves the Authentication Key.

53. A method as in claim 48, whereby
the step of reading performs the function of an Authenticator for CSS Decryption Module; and
the step of playing back peforms the function of a Descrambler;
as those terms defined in the CSS Procedural Specifications.

54. A method as in claim 48, whereby, when the step of reading begins, it includes the step of obtaining software from the storage element.

55. A method as in claim 48, whereby, when the step of playing back begins, it includes the step of obtaining software from the storage element.

56. A method as in claim 55, whereby the operating software for the step of reading, the storage element, and the step of playing back is not based on a general-purpose operating system such as Microsoft Windows, or Linux, or a version of Unix.

57. A method as in claim 48, whereby, the audio data output from the step of playing back is either in a compressed format or else in a Linear PCM format in which the transmission information is sampled at no more than 48 kHz and no more than 16 bits.

58. A method as in claim 48, whereby, the analog video data output from the step of playing back does not have higher resolution than standard definition, unless the content recorded on the physical medium has itself that higher resolution.

59. A method as in claim 45, wherein the protected form includes at least two of:
an encrypted form of the digital content;
an encrypted form of the digital content complying with the CSS license;
a form of the digital content including digital rights information;
a form of the digital content including digital rights information for which it is substantially difficult to remove that digital rights information.

60. A method as in claim 45, wherein the protected form includes
an encrypted form of the digital content complying with the CSS license; and
an additional layer of protection, by any technique, for any substantial portion of the steps of reading, storing, and playing back.

61. A method as in claim 45, wherein the physical media includes at least one DVD and the step of reading occurs in at least one DVD drive in a media reader.

62. A method as in claim 45, wherein
the physical media includes at least one high-definition optical disc, in at least one of the following formats: Blu-Ray, HD-DVD, another format requiring a blue laser; and
the step of reading that optical disc in a media reader includes a blue laser.

63. A method as in claim 61, wherein the media reader includes a first authenticator.

64. A method as in claim 63, wherein the method complies with CSS procedures.

65. A method as in claim 64, wherein part of complying with said CSS procedures includes having the first authenticator and a second authenticator authenticate each other before permitting access to data.

66. A method as in claim 64, wherein part of complying with said CSS procedures includes using CSS descrambling procedures.

67. A method as in claim 64, wherein part of complying with said CSS procedures includes extracting keys that can be used to descramble CSS data, by an indirect manner from the key materials copied from the optical disc, using a key associated with the playback device, that key not being available from the optical disc.

68. A method as in claim 64, wherein part of complying with said CSS procedures includes having the first authenticator and the second authenticator authenticate each other before the media reader permits access to data, and using CSS descrambling procedures.

69. A method as in claim 45, wherein at least two of the following steps occur at logically remote locations: the step of reading, the step of non-evanescently storing, and the step of playing back.

70. A method as in claim 45, wherein at least two of the following steps occur at physically remote locations: the step of reading, the step of non-evanescently storing, and the step of playing back.

71. A method as in claim 45, wherein the step of playing back occurs at a plurality of playback devices, at least two of those playback devices being pairwise substantially physically remote from each other.

72. A method as in claim 45, wherein a substantial time duration occurs between the step of non-evanescently storing and the step of playing back.

73. A method as in claim 74, wherein the digital content is transported any substantial distance between the step of reading and the step of playing back.

74. A method as in claim 45, wherein the digital content is transported any substantial distance between the step of reading and the step of playing back.

75. A method as in claim 45, wherein at least one system internal link is used between two of the steps of reading, non-evanescently storing, and playing back, the at least one system internal link including a link able to communicate compressed digital data representing media streams but which need not be substantially able to effectively and timely communicate uncompressed digital data representing media streams; and
wherein any key materials in data communicated using the system internal link is not substantially accessible to an external entity without an authorized cryptographically secure key.

76. A method of doing business, including steps of sending data from a device that reads a physical medium to a remote playback device while complying with CSS license agreement terms and CSS procedural specification terms.

77. A method of doing business as in claim 76, wherein the steps of sending data to a remote playback device include causing that playback device to be ready to playback that data.

78. A method of doing business as in claim 76, wherein the physical medium is a DVD.

79. A method of doing business as in claim 76, wherein the device that reads the physical medium and the remote playback device have separate controlling CPUs, and have at least one of the properties in the set: being logically remote, being physically remote.

80. A method of doing business as in claim 76, including steps of storing data from the physical medium in a storage element capable of non-evanescently storing that digital content using a storage technique substantially different from the physical medium.

81. A method of doing business as in claim 76, including steps of storing data from the physical medium in a storage element capable of non-evanescently storing that digital content using a storage technique substantially different from the physical medium; and
wherein the playback device is coupled to the storage element, the playback device having an input disposed for receiving the digital content and having an output disposed for coupling a media stream represented by that digital content for presentation.

82. A method of doing business as in claim 81, whereby the playback device includes a CSS descrambler.

83. A method of doing business as in claim 81, wherein the playback device includes a plurality of those outputs disposed for presentation, at least two of those outputs pairwise have separate controlling CPUs, and have at least one of the properties in the set: being logically remote, being physically remote.

84. A method of doing business as in claim 81, wherein the playback device includes at least one of those outputs disposed for presentation and having at least one of the properties in the set: being logically remote from the storage element, being physically remote from the storage element, having a distinct controlling CPU from the storage element.

85. A method of doing business as in claim 81, wherein data is read from the physical medium by a media player before being sent to the storage element, and wherein the media reader includes a read element capable of being coupled to the physical medium, the digital content being maintained in a protected form between the media reader and at least one of: the storage element, the playback device.

86. A method of doing business as in claim 85, wherein
at least two elements in the set: the storage element, the playback device, the media reader;
have collectively more than one controlling CPU, and have pairwise, at least one of the properties in the set: being logically remote, being physically remote.

87. A method of doing business as in claim 85, wherein the digital content is maintained in a protected form for substantially an entire path including:
between the physical medium and the media reader;
between the media reader and the storage element;
when maintained on the storage element;
between the storage element and the playback device.

88. A method of doing business as in claim 85, wherein the protected form includes at least two of:
an encrypted form of the digital content;
an encrypted form of the digital content complying with the CSS license;
a form of the digital content including digital rights information;
a form of the digital content including digital rights information for which it is substantially difficult to remove that digital rights information.

89. A method of doing business as in claim 85, wherein the protected form has at least one of the properties in the set:
resistant to attempts to defeat copy protection afforded by the protected form,
impossible to defeat using user tools,
difficult to defeat using professional tools.

90. A method of doing business as in claim 85, wherein the protected form has at least two of the properties in the set:
resistant to attempts to defeat copy protection afforded by the protected form,
impossible to defeat using user tools,
difficult to defeat using professional tools.

91. A method of doing business as in claim 85, wherein the protected form is substantially resistant to attempts to defeat copy protection afforded by the protected form, is substantially impossible to defeat using user tools, and is substantially difficult to defeat using professional tools.

92. A method of doing business as in claim 81, wherein the storage element has capacity to concurrently store digital content from plural physical media.

93. A method of doing business as in claim 81, wherein
at least one possible output from the playback device includes an analog audiovisual content; and
the second protected form by which the analog audiovisual content is protected includes analog copy protection.

94. A method of doing business as in claim 93, wherein the analog copy protection is Macrovision copy protection.

95. A method of doing business as in claim 81, wherein
at least one output from the playback device includes a digital audiovisual content; and
the second protected form by which the digital audiovisual content is protected includes a technique substantially like HDCP.

96. A method of doing business as in claim 81, wherein operation of the system includes at least a substantial time duration between a first time of storage of the digital content at the storage element, and a second time of output of any media stream derived in response thereto.

97. A method of doing business as in claim 81, wherein the digital content is transported any substantial distance after being read by the media reader and before being output by the playback device.

98. A method of doing business as in claim 81, including at least one system internal link, the at least one system internal link including a link able to communicate compressed digital data representing media streams;
wherein at least one of the following communicated using the system internal link is not substantially accessible to an external entity without an authorized cryptographically secure key: digital information representing at least one media stream, DRM information, DRM key information.

99. A method of doing business as in claim 98, including steps of coupling by a least one system internal link, at least two of the set: the media reader, the storage element, the playback device.

100. A method of doing business as in claim 81, wherein data is read from the physical medium by a media player before being sent to the storage element, and wherein the media reader includes
a read element for physical media, the physical media including digital content representing at least one media stream, the digital content being maintained in a protected form, and the read element including a first authenticator;
a second authenticator;
an interface to a storage element; and
a controller capable of (1) causing the first authenticator and the second authenticator to authenticate each other before the read element accesses the physical media, and (2) causing the read element to read data from the physical media and output the data to the interface with DRM information intact.

101. A method of doing business as in claim 100, wherein the read element includes a DVD drive.

102. A method of doing business as in claim 100, wherein the media reader can output the data to the storage element whether or not the storage element is logically remote from the media reader.
